(19) United States
(12) Patent Application Publication
(10) Pub. No.: US 2019/0301717 A1
(43) Pub. Date: Oct. 3, 2019

(54) LIGHT SOURCE, LIGHT FIXTURE, AND POWER SUPPLY DEVICE

(71) Applicant: PANASONIC INTELLECTUAL PROPERTY MANAGEMENT CO., LTD., Osaka (JP)

(72) Inventors: Tadahiro KONO, Osaka (JP); Akihiro HIRANO, Shiga (JP); Katsunobu HAMAMOTO, Osaka (JP)

(73) Assignee: PANASONIC INTELLECTUAL PROPERTY MANAGEMENT CO., LTD., Osaka (JP)

(21) Appl. No.: 16/360,731

(22) Filed: Mar. 21, 2019

(30) Foreign Application Priority Data
Mar. 27, 2018 (JP) 2018-060690

(51) Int. Cl. F21V 23/02; F21V 23/00; F21V 19/00

(52) U.S. Cl. CPC F21V 23/023; F21V 19/003; F21V 23/004; F21V 23/002

(57) ABSTRACT

A light source is provided that includes an attachment member, a light source section, a power supply device, and a conductor. The attachment member includes a plate portion and a through hole. The light source section includes a first board, a light emitter, a first terminal, and a first hole. A power supply circuit of the power supply device includes a second board, a second hole, a holder, and a second terminal. The holder is arranged along one surface, facing away from the plate portion, of the second board. The second terminal is held by the holder. The first terminal, the first hole, the through hole, the second hole, and the second terminal overlap with each other in the thickness direction of the plate portion. The conductor is electrically connected to the first terminal and the second terminal through the first hole, the through hole, and the second hole.

### CROSS-REFERENCE TO RELATED APPLICATION

The application is based upon and claims the benefit of priority to Japanese Patent Application No. 2018-60690, filed on Mar. 27, 2018, the entire contents of which are hereby incorporated by reference.

### TECHNICAL FIELD

The present disclosure relates to a light source, a light fixture, and a power supply device.

### BACKGROUND ART

JP 2017-174568 A discloses a light fixture. The light fixture is made up of a fixture body mountable on a ceiling, and a light source attached to the fixture body. The light source includes an attachment member, a light source section, and a power supply device.

The light source section includes a board and a solid-state light source mounted on the board. The board is attached to the lower surface of the attachment member with the solid-state light source facedown. The lower surface of the board has an input terminal portion. A first terminal member is soldered to the input terminal portion.

The power supply device includes a power supply circuit. The power supply circuit includes a printed wiring board and a holder. The printed wiring board is attached to the upper surface of the attachment member. The lower surface of the printed wiring board has an output terminal portion. The holder is attached to the lower surface of the printed wiring board. The holder holds a second terminal member. The second terminal member is soldered to the output terminal portion.

The attachment member has a hole that runs vertically through itself. A bar-shaped conductor is passed through this hole. A lower end portion of the conductor is electrically connected to the first terminal member, while an upper end portion of the conductor is electrically connected to the second terminal member. The power generated by the power supply circuit is supplied to the solid-state light source via the second terminal member, the conductor, the first terminal member, and the board. This light fixture allows the light source section to be electrically connected to the power supply device just by passing the conductor through the board of the light source section and the hole of the attachment member, thus facilitating the installation of a light fixture.

In the light fixture, however, the holder protrudes downward from the printed wiring board, which makes it so difficult to arrange the printed wiring board close to the upper surface of the attachment member that there tends to be a long distance between the first terminal member and the second terminal member. Such a long distance between the first and second terminal members would make it so difficult to shorten the length of the conductor that there is concern about producing radiation noise, which is a problem with the light fixture described above.

### SUMMARY

Thus, the present disclosure provides a light source, a light fixture and a power supply device that are installable easily and reduce the chances of producing radiation noise.

A light source according to an aspect of the present disclosure includes an attachment member, a light source section, a power supply device, and at least one conductor. The light source section is attached to the attachment member. The power supply device is attached to the attachment member. The attachment member includes a plate portion and a through hole. The through hole is cut through the plate portion so as to run through the plate portion in a thickness direction of the plate portion. The light source section includes a first board, a light emitter, at least one first terminal, and at least one first hole. The first board is arranged along one of two surfaces of the plate portion. The two surfaces face each other in the thickness direction of the plate portion. The light emitter is attached to the first board. The at least one first terminal is attached to the first board and electrically connected to the light emitter. The at least one first hole runs through the first board in the thickness direction. The power supply device includes a power supply circuit. The power supply circuit includes a second board, at least one second hole, a holder, and at least one second terminal. The second board is arranged along the other of the two surfaces, facing away from the first board, of the plate portion. The at least one second hole runs through the second board in the thickness direction. The holder is arranged on one of two surfaces, facing away from the plate portion, of the second board. The at least one second terminal is held by the holder to output power generated by the power supply circuit. The at least one first terminal, the at least one first hole, the through hole, the at least one second hole, and the at least one second terminal overlap with each other when viewed in the thickness direction. The conductor is electrically connected to the at least one first terminal and the at least one second terminal through the at least one first hole, the through hole, and the at least one second hole.

A light fixture according to another aspect of the present disclosure includes: the light source described above; and a fixture body. The fixture body supports the light source.

A power supply device according to still another aspect of the present disclosure includes a power supply circuit. The power supply circuit includes a board, at least one hole, a holder, and at least one terminal. The at least one hole is cut through the board so as to run through the board in a thickness direction of the board. The holder is arranged on one of two surfaces of the board. The two surfaces face each other in the thickness direction. The at least one terminal is held by the holder to output power generated by the power supply circuit. The at least one hole is cut through a portion of the board, located to face the at least one terminal, of the board.

### BRIEF DESCRIPTION OF DRAWINGS

Preferred embodiments of the invention will now be described in further detail. Other features and advantages of the invention will become better understood with regard to the following detailed description and accompanying drawings where:

FIG. 1 is an exploded perspective view of a light fixture according to an embodiment of the present disclosure;

FIG. 2 is a cross-sectional view of the light fixture that is installed;

FIG. 3 is an exploded perspective view of a part, including a power supply device for a light source, of the light fixture;

FIG. 4 is an exploded perspective view of an attachment member, a light source section, and a cover, all of which form parts of the light source;

FIG. 5 is a front view of a first terminal for the light source;

FIG. 6 is a plan view of the first terminal of the light source;

FIG. 7 is a side view of the first terminal of the light source;

FIG. 8 is a cross-sectional view, taken along a plane perpendicular to the rightward/leftward direction, of a principal portion of the light source;

FIG. 9 is a cross-sectional view, taken along a plane IX-IX shown in FIG. 8, of the light source;

FIG. 10 is a plan view of a board and a plurality of electronic parts, all of which form parts of the power supply device;

FIG. 11 is a bottom view of the power supply device;

FIG. 12 is an exploded perspective view of a holder and a second terminal, both of which form parts of the power supply device;

FIG. 13 is an exploded perspective view of a power supply device according to a first variation;

FIG. 14 is an exploded perspective view of a principal portion of a power supply device according to a second variation;

FIG. 15 is a perspective view of the principal portion of the power supply device;

FIG. 16 is an exploded perspective view of a principal portion of a power supply device according to a third variation;

FIG. 17 is a perspective view of the principal portion of the power supply device;

FIG. 18 is an exploded perspective view of a principal portion of a power supply device according to a fourth variation;

FIG. 19 is a perspective view of the principal portion of the power supply device; and

FIG. 20 is a perspective view of a second terminal, which forms part of a power supply device according to a fifth variation.

### DESCRIPTION OF EMBODIMENTS

Embodiments of the present disclosure relate to a power supply device, a light source (light source unit) including the power supply device and a light emitter, and a light fixture including the light source.

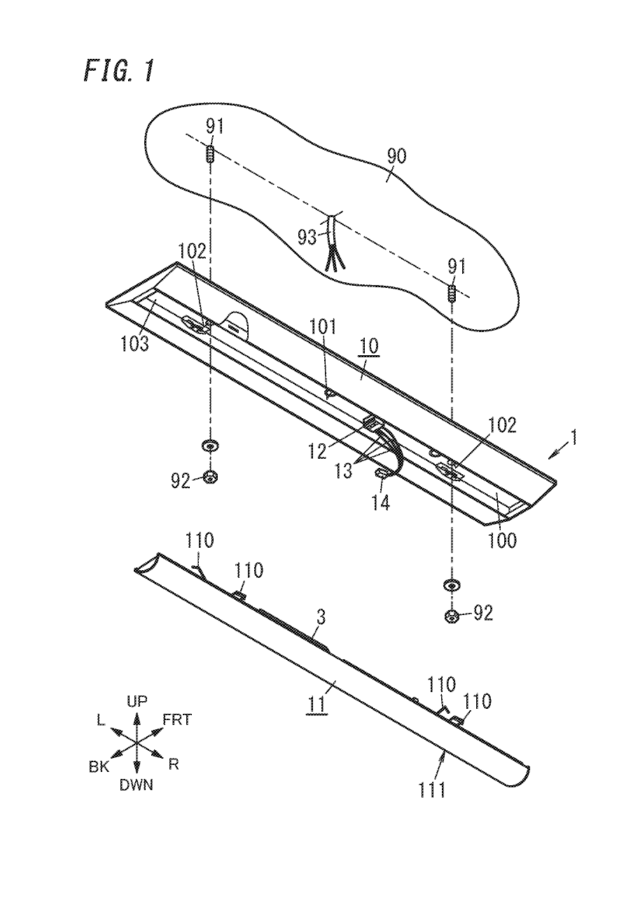

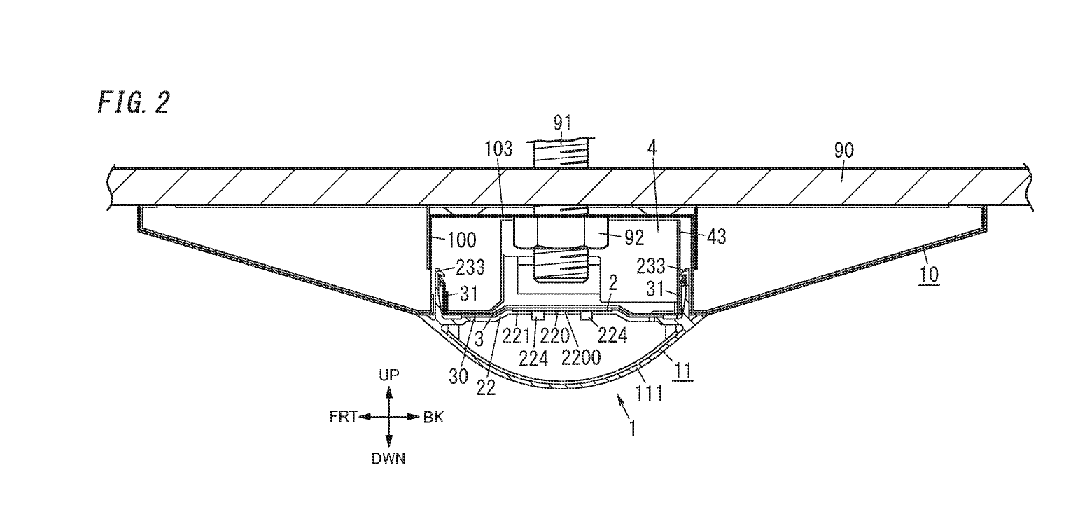

As shown in FIGS. 1 and 2, a light fixture 1 according to an exemplary embodiment is a light fixture designed to be mounted directly on a ceiling. The light fixture 1 is arranged on the lower surface of a ceiling panel 90 and attached to the ceiling panel 90 with suspension bolts 91. In the following description, respective constituent members of the light fixture 1 will be described by reference to the directions determined when the light fixture 1 is installed on the ceiling.

Note that the technique disclosed herein is applicable to not only such a light fixture to be mounted directly on a ceiling but also various other types of light fixtures. For example, the technique of the present disclosure is applicable to a light fixture to be mounted to a ceiling via a ceiling rosette or any other appropriate member, a light fixture to be mounted onto a wall surface or a piece of furniture, and a light fixture to be used by itself without being attached to any other member. Likewise, the technique of the present disclosure is also applicable to a light source to be assembled in any of various devices other than light fixtures and to a power supply device to be built in various devices other than light source.

The light fixture 1 includes a fixture body 10 and a light source 11. The fixture body 10 is mountable on the ceiling panel 90. The fixture body 10 according to this embodiment is mounted on the ceiling panel 90 by being fixed onto suspension bolts 91. The light source 11 is detachably attached to, and supported by, the fixture body 10.

The fixture body 10 horizontally extends linearly and is formed in the shape of a shallow compressed box with a top opening. In the following description, the rightward/leftward direction will be defined by the length of the fixture body 10 and the forward/backward direction will be defined by the width of the fixture body 10.

The fixture body 10 is made of a metallic material and may be formed by bending a sheet metal, for example. The lower surface of the fixture body 10 has a recess 100 to house the light source 11 therein. The recess 100 is a linear groove extending through the fixture body 10 in the rightward/leftward direction. The fixture body 10 includes a bottom plate 103 defining the bottom of the recess 100.

The bottom plate 103 has a port 101 and a plurality of holes 102. The port 101 is provided to allow a power cable 93 to pass through it and vertically runs through the bottom plate 103. The plurality of holes 102 are provided to allow the suspension bolts 91 to pass through them and also vertically run through the bottom plate 103.

The light fixture 1 of this embodiment further includes a terminal stage 12, a plurality of electric wires 13, and a plug connector 14. The terminal stage 12 is attached to the lower surface of the bottom plate 103. The power cable 93 passed through the port 101 is electrically connected to the terminal stage 12. The plug connector 14 is also electrically connected to the terminal stage 12 via the plurality of electric wires 13.

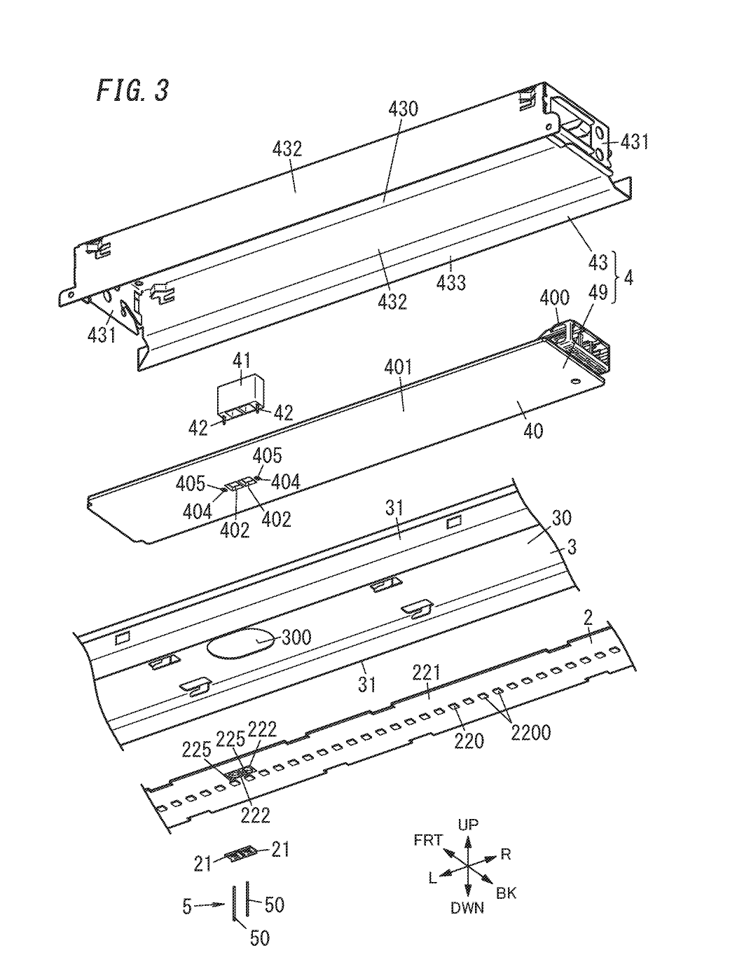

As shown in FIGS. 2 and 3, the light source 11 includes an attachment member 3, a light source section 2, a power supply device 4, and a connection member 5. The light source section 2 and the power supply device 4 are each attached to the attachment member 3. The power supply device 4 generates output power based on input power. The connection member 5 electrically connects the power supply device 4 and the light source section 2 together. The power generated by the power supply device 4 is supplied to the light source section 2 via the connection member 5.

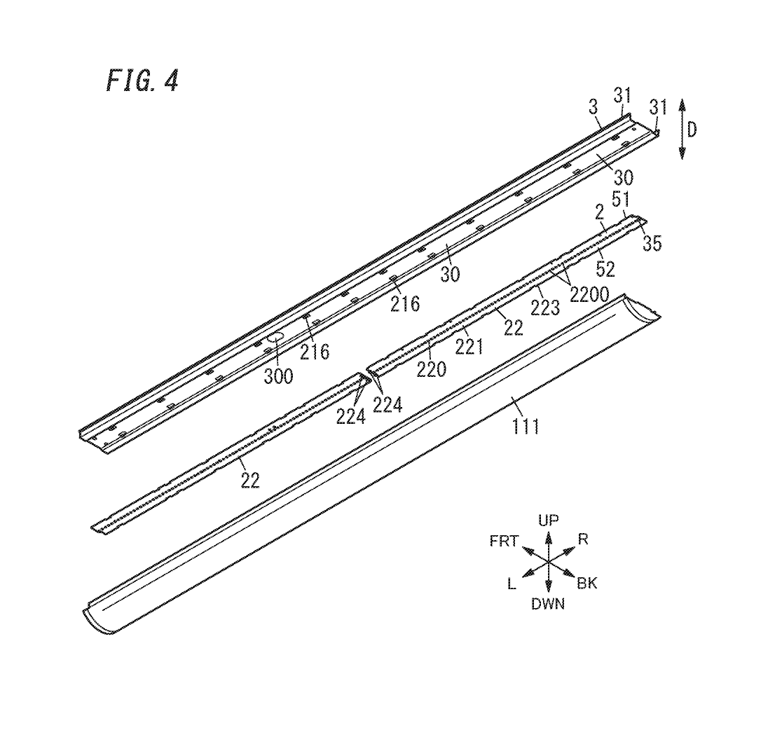

As shown in FIG. 4, the attachment member 3 is formed as a linear plate extending in the rightward/leftward direction. The attachment member 3 may be made of a metallic material and may be formed by bending a sheet metal, for example. However, this is only an example and should not be construed as limiting. Alternatively, the attachment member 3 may also be made of a non-metallic material such as a resin.

The attachment member 3 of this embodiment has a U-cross section when viewed along a plane perpendicular to the rightward/leftward direction, and includes a bottom plate portion 30 and a pair of side plate portions 31. The bottom plate portion 30 constitutes a plate portion arranged between the light source section 2 and the power supply device 4 (see FIG. 2).

The bottom plate portion 30 is formed in the shape of a rectangular plate, of which the length (corresponding to the longitudinal axis of the light source 11) is parallel to the rightward/leftward direction and the thickness D (corresponding to the depth axis of the light source 11) is parallel to the upward/downward direction. The pair of side plate portions 31 protrudes upward from front and rear ends of the bottom plate portion 30. The attachment member 3 further has a through hole 300. The through hole 300 is cut through, and vertically runs through, the bottom plate portion 30. The through hole 300 is an elongated hole, of which the longitudinal axis is parallel to the rightward/leftward direction.

The light source section 2 is arranged on the lower surface of the bottom plate portion 30. The light source section 2 includes a plurality of light source modules 22. The light source section 2 of this embodiment includes two light source modules 22. However, this is only an example and should not be construed as limiting. Alternatively, the light source section 2 may also include three or more light source modules 22 or only one light source module 22 as well.

The plurality of light source modules 22 are arranged side by side in the rightward/leftward direction. Each of the light source modules 22 includes a board (printed wiring board) 221 and a light emitter 220. In the following description, the board 221 will be hereinafter referred to as a “first board 221.”

The respective first boards 221 of the two adjacent light source modules 22 are arranged side by side along the lower surface of the bottom plate portion 30. Each of these first boards 221 is formed in the shape of a rectangular plate, of which the length (longitudinal axis) is parallel to the rightward/leftward direction and the thickness (depth axis) is parallel to the upward/downward direction.

Each of the first boards 221 is supported, and thereby fixed onto the bottom plate portion 30, by a plurality of claws 216 provided for the bottom plate portion 30 of the attachment member 3. Each of the first boards 221 includes a board body (insulating substrate) 223 and printed wiring formed on the lower surface of the board body 223. The printed wiring may be made of an electrical conductor such as copper foil.

A light emitter 220 is attached (mounted) onto each of the first boards 221. The light emitter 220 includes a plurality of light-emitting elements 2200 (see FIG. 3), which are arranged side by side in the rightward/leftward direction along the lower surface (i.e., a surface facing away from the bottom plate portion 30) of its associated first board 221. Each of those light-emitting elements 2200 is a solid-state light-emitting element and may be implemented as a light-emitting diode, for example. Each of those light-emitting elements 2200 is electrically connected to the printed wiring of its associated first board 221.

Note that the respective light-emitting elements 2200 do not have to be light-emitting diodes but may also be implemented as semiconductor light-emitting elements such as semiconductor laser diodes, organic electroluminescent elements, or inorganic electroluminescent elements. Alternatively, each light emitter 220 may also consist of a single light-emitting element.

Any one of the plurality of light source modules 22 includes at least one first hole 225 and at least one input terminal portion 222 as shown in FIG. 3. In this embodiment, any one of the plurality of light source modules 22 includes a pair of first holes 225 as the at least one first hole 225 and a pair of input terminal portions 222 as the at least one input terminal portion 222. However, this is only an example and should not be construed as limiting. Alternatively, any one of the plurality of light source modules 22 may also include only one first hole 225 and only one input terminal portion 222, or three or more first holes 225 and three or more input terminal portions 222 as well.

The pair of first holes 225 are cut through the first board 221 and are arranged side by side in the rightward/leftward direction. Each of the first holes 225 vertically runs through a portion, located to face the through hole 300 of the attachment member 3, of the first board 221.

The pair of input terminal portions 222 are associated one to one with the pair of first holes 225. Each input terminal portion 222 is formed in the shape of a land, surrounding an associated one of the first holes 225, on the lower surface of the first board 221. The pair of input terminal portions 222 is electrically connected to the plurality of light-emitting elements 2200 via the printed wiring of the first board 221.

As shown in FIGS. 2 and 4, each light source module 22 of this embodiment further includes a pair of connectors 224. In each light source module 22, the pair of connectors 224 are attached to the lower surface of the first board 221. The respective printed wirings of two adjacent first boards 221 are electrically connected together by electrically connecting the pair of connectors 224 attached to one first board 221 to the pair of connectors 224 attached to the other first board 221. This allows the pair of input terminal portions 222 to be electrically connected to the plurality of light-emitting elements 2200 attached to the first board 221 with no input terminal portions 222.

The light source section 2 further includes at least one first terminal 21 shown in FIG. 3. In this embodiment, the light source section 2 includes a pair of first terminals 21 as the at least one first terminal 21. However, this is only an example and should not be construed as limiting. Alternatively, the light source section 2 may include only one first terminal 21 or three or more first terminals 21 as well.

The pair of first terminals 21 receive the power supplied from the power supply device 4 to the light source section 2 via the connection member 5. The pair of first terminals 21 are associated one to one with the pair of input terminal portions 222. Each of the first terminals 21 is arranged on the lower surface of the first board 221. Each of the first terminals 21 is joined, and thereby electrically connected, to its associated input terminal portion 222. This allows each of the first terminals 21 to be electrically connected to the respective light-emitting elements 2200 via its associated input terminal portion 222.

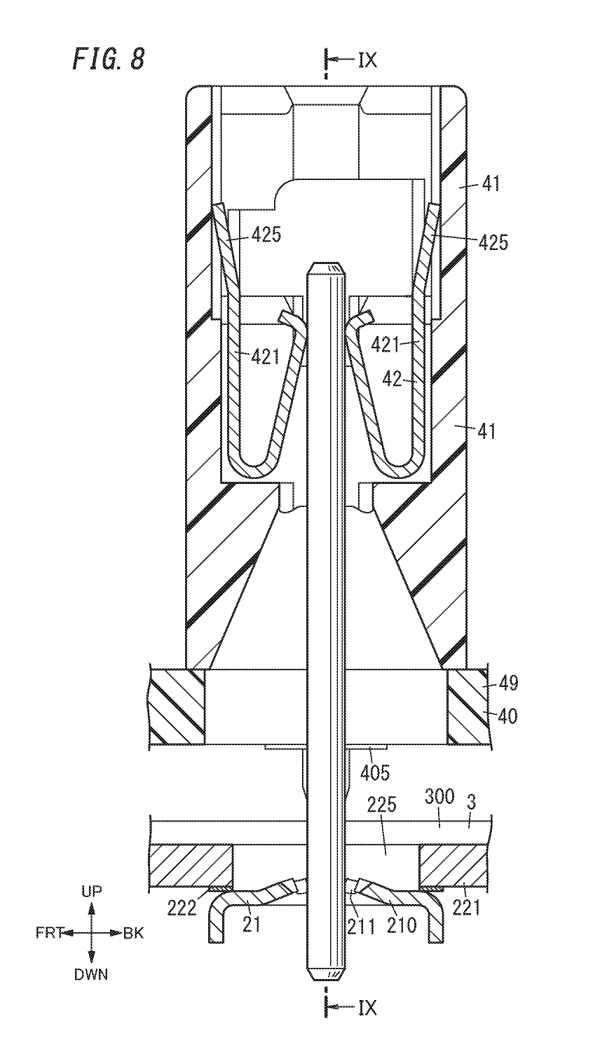

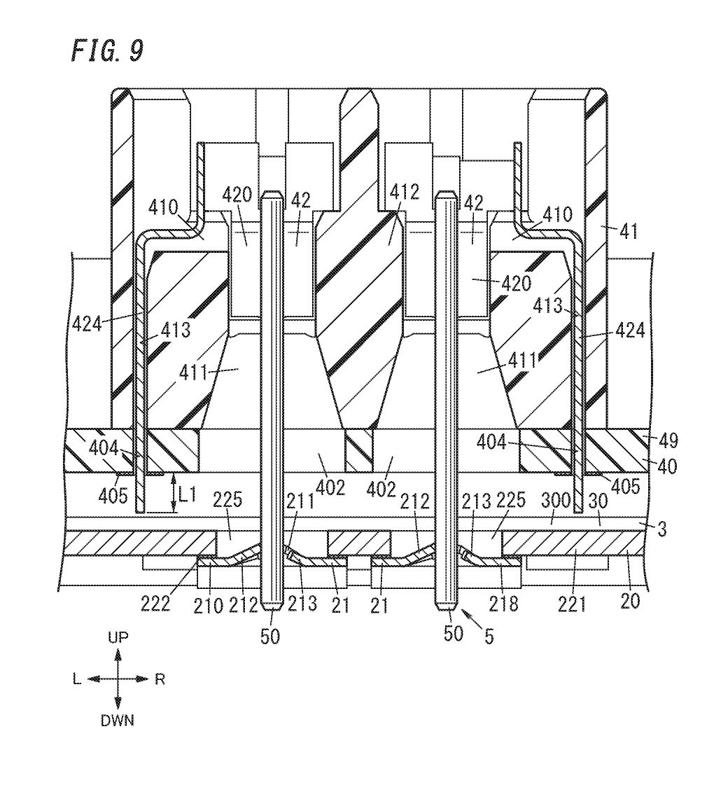

Each of the first terminals 21 is made of a metallic material. Each of the first terminals 21 includes a plate portion 210, of which the thickness is parallel to the upward/downward direction, as shown in FIGS. 5-7. As shown in FIGS. 8 and 9, the plate portion 210 is arranged along the lower surface of the first board 221. Each of the first terminals 221 has an insertion hole 211 vertical running through a center portion of the plate portion 210. When viewed vertically, the insertion hole 211 of each of the first terminals 21 overlaps with its associated first hole 225.

As shown in FIGS. 5-7, each of the first terminals 21 further includes a plurality of (e.g., three in the example illustrated on the drawings) supporting pieces 212 and a plurality of (e.g., three in the example illustrated on the drawings) guide pieces 213. The plurality of supporting pieces 212 and the plurality of guide pieces 213 are provided around the periphery of the insertion hole 211. The supporting pieces 212 and the guide pieces 213 are alternately arranged along the circumference of the insertion hole 211. Each of these supporting pieces 212 and guide pieces 213 may be formed by cutting and bending diagonally upward a portion of the plate portion 210, for example.

These supporting pieces 212 and guide pieces 213 protrude, when viewed vertically, from the periphery of the insertion hole 211 toward the center of the insertion hole 211. Each supporting piece 212 and each guide piece 213 are tilted with respect to a plane perpendicular to a vertical axis so as to upwardly slope away from the plane toward the center of the insertion hole 211. In this case, the tip of each supporting piece 212 protrudes closer to the center of the insertion hole 211 than that of any of the plurality of guide pieces 213.

The plate portion 210 of each of the first terminals 21 is soldered to its associated input terminal portion 222 as shown in FIG. 9. This allows each of the first terminals 21 to be electrically connected to its associated input terminal portion 222. The plurality of supporting pieces 212 and plurality of guide pieces 213 of each of the first terminals 21 are arranged inside of their associated first hole 225.

As shown in FIG. 3, the power supply device 4 includes a power supply circuit 49 and a case 43. The power supply circuit 49 is housed in the case 43.

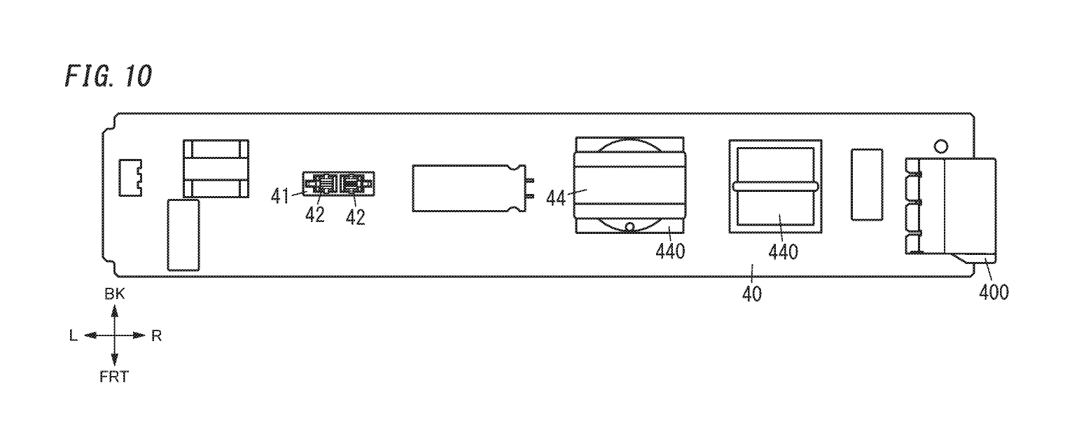

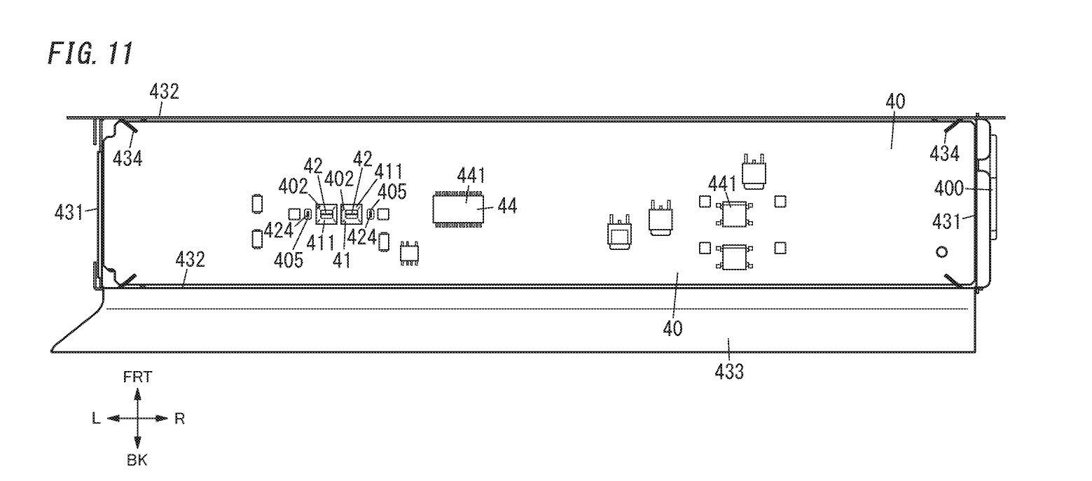

The power supply circuit 49 is a circuit for converting AC power supplied from an AC power supply into DC power. That is to say, the power supply circuit 49 receives AC power as input power and delivers DC power as output power. The power supply circuit 49 includes a board (printed wiring board) 40 and a plurality of electronic parts 44 (see FIGS. 10 and 11) attached (or mounted) onto the board 40. In the following description, the board 40 will be hereinafter referred to as a “second board 40.”

The second board 40 is arranged along the upper surface (i.e., the surface facing away from the first board 221) of the bottom plate portion 30 of the attachment member 3. The second board 40 is formed in the shape of a rectangular plate, of which the length (longitudinal axis) is parallel to the rightward/leftward direction and the thickness (depth axis) is parallel to the upward/downward direction. The second board 40 includes a board body (insulating substrate) 401 and printed wiring formed on the lower surface of the board body 401. The printed wiring may be made of an electrical conductor such as copper foil.

In this embodiment, the upper surface (i.e., the surface facing away from the bottom plate portion 30) of the second board 40 serves as a component side, and the lower surface (i.e., the surface facing the bottom plate portion 30) of the second board 40 serves as a solder side. The plurality of electronic parts 44 includes a plurality of electronic parts 440 arranged on the upper surface of the second board 40 as shown in FIG. 10 and a plurality of electronic parts 441 arranged on the lower surface of the second board 40 as shown in FIG. 11.

Each of the plurality of electronic parts 44 shown in FIG. 10 includes a power supply input section 400 implemented as a receptacle connector and a so-called “lead part” such as a smoothing capacitor or a common mode choke coil. One, having the longest vertical dimension, of the plurality of electronic parts 441 has a shorter vertical dimension than one, having the longest vertical dimension, of the plurality of electronic parts 440. In other words, the longest protrusion length of any of the plurality of electronic parts 441 protruding downward from the second board 40 is shorter than the longest protrusion length of any of the plurality of electronic parts 440 protruding upward from the second board 40. This allows the second board 40 to be arranged closer to the bottom plate portion 30 of the attachment member 3.

As shown in FIGS. 3 and 9, the power supply circuit 49 further has at least one second hole 402, at least one through hole 404, and at least one output terminal portion 405. In this embodiment, the power supply circuit 49 has a pair of second holes 402 as the at least one second hole 402. Also, the power supply circuit 49 of this embodiment has a pair of through holes 404 as the at least one through hole 404 and includes a pair of output terminal portions 405 as the at least one output terminal portion 405. However, this is only an example and should not be construed as limiting. Alternatively, the power supply circuit 49 may have only one second hole 402, one through hole 404 and one output terminal portion 405, or may even have three or more second holes 402, three or more through holes 404, and three or more output terminal portions 405.

All of the pair of second holes 402 and pair of through holes 404 are provided for a portion, located to face the through hole 300 of the attachment member 3, of the second board 40, and vertically run through the second board 40. The pair of second holes 402 are associated one to one with the pair of first holes 225 of the first board 221 and are arranged side by side in the rightward/leftward direction. The pair of through holes 404 are spaced apart from each other in the rightward/leftward direction. The pair of second holes 402 are located between the pair of through holes 404.

The pair of output terminal portions 405 are associated one to one with the pair of through holes 404. Each output terminal portion 405 is formed in the shape of a land, surrounding an associated one of the through holes 404, on the lower surface of the second board 40. The pair of output terminal portions 405 are electrically connected to the printed wiring of the second board 40.

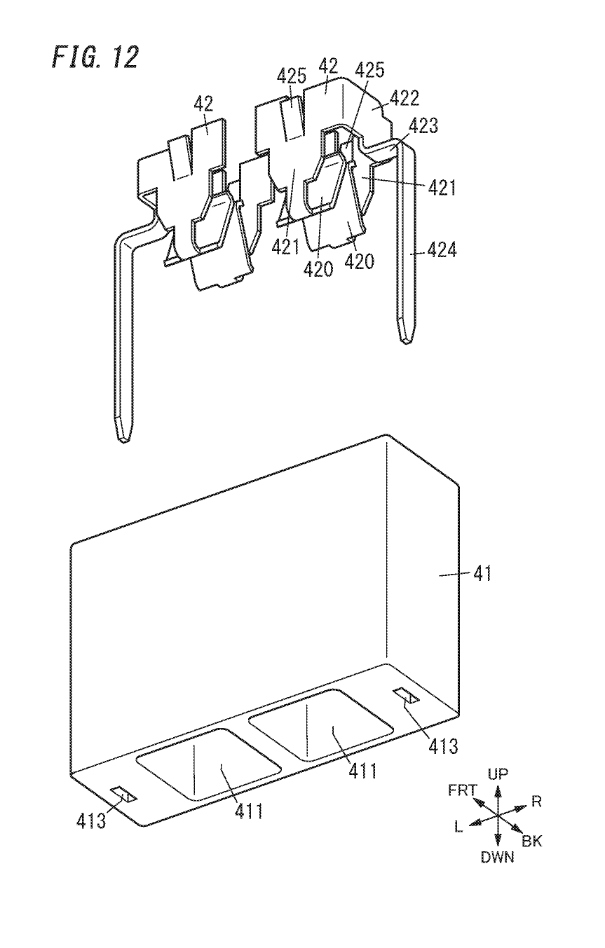

The power supply circuit 49 further includes the holder 41 shown in FIG. 12 and at least one second terminal 42 held by the holder 41. In this embodiment, the power supply circuit 49 includes a pair of second terminals 42 as the at least one second terminal 42. However, this is only an example and should not be construed as limiting. Alternatively, the power supply circuit 49 may include only one second terminal 42 or may even include three or more second terminals 42.

As shown in FIG. 9, the holder 41 is arranged along the upper surface of the second board 40. The holder 41 has electrical insulating properties and may be made of a resin, for example. The holder 41 is formed in the shape of a rectangular parallelepiped, of which the length (longitudinal axis) is parallel to the rightward/leftward direction.

The holder 41 has a pair of housings 410, which are provided in an upper portion of the holder 41. The pair of housings 410 are arranged side by side in the rightward/leftward direction. Each of the housings 410 is defined by a hole cut through the upper surface of the holder 41. The pair of second terminals 42 are respectively housed in the pair of housings 410. This allows the pair of second terminals 42 to be arranged along the upper surface of the second board 40. The pair of second terminals 42 are associated one to one with the pair of second holes 402. That is to say, the pair of second holes 402 are cut through portions, located to face the pair of second terminals 42, respectively, of the second board 40. These second terminals 42 are configured to be connected to conductors 50 (to be described later) passed through their associated second holes 402.

The holder 41 further includes a partition wall 412. The partition wall 412 is provided as a partition between the pair of housings 410. The partition wall 412 electrically insulates the pair of second terminals 42 from each other.

The pair of second terminals 42 is used to supply the power generated by the power supply circuit 49 to an external device. The pair of second terminals 42 are arranged side by side in the rightward/leftward direction and are associated one to one with the pair of output terminal portions 405. Each of the second terminals 42 is made of a metallic material, and is electrically connected to an associated one of the output terminal portions 405. This allows each of the second terminals 42 to be electrically connected to the printed wiring of the second board 40 via its associated output terminal portion 405.

Each of the second terminals 42 is formed integrally by patterning a metal plate of copper or a copper alloy, for example. As shown in FIG. 12, each second terminal 42 includes a pair of counter pieces 421 and a connecting piece 422. The pair of counter pieces 421 face each other with a gap left between themselves in the forward/backward direction.

Each of the pair of counter pieces 421 includes an upwardly protruding hook 425. Each hook 425 tilts with respect to a vertical axis (upward/downward direction) so as to outwardly slope away, in the forward/backward direction, from an associated one of the counter pieces 421 toward the top thereof. Each hook 425 may be formed by cutting and bending diagonally outward a portion of its associated counter piece 421, for example. Each hook 425 is caught by an inner wall surface of its associated housing 410 as shown in FIG. 8. This prevents each of the second terminals 42 from unintentionally pulling itself out upward and allows the second terminal 42 to be fixed onto the holder 41.

As shown in FIG. 12, the pair of counter pieces 421 has their respective ends, which are located, in the rightward/leftward direction, outside of their associated one of the pair of second terminals 42, connected together with the connecting piece 422. Each of the second terminals 42 further includes a flexible piece 423 and a terminal piece 424. Each flexible piece 423 protrudes outward in the rightward/leftward direction with respect to the associated one of the pair of second terminals 42 from the bottom of its associated connecting piece 422. Each terminal piece 424 protrudes downward (i.e., toward the bottom plate portion 30 of the attachment member 3) from the other end, opposite in the rightward/leftward direction from the end connected to the connecting piece 422, of its associated flexible piece 423.

As shown in FIG. 9, the holder 41 further has a pair of housing holes 413. The pair of housing holes 413 are cut through respective portions, located at right and left ends, of a lower part of the holder 41. Each of the housing holes 413 has its top communicating with its associated housing 410 and its bottom opening through the lower surface of the holder 41. Each of the housing holes 413 houses the terminal piece 424 of an associated one of the second terminals 42. Each terminal piece 424 protrudes downward from the lower surface of the holder 41.

A lower end portion of each terminal piece 424 runs through an associated through hole 404 of the second board 40 and protrudes downward from the second board 40 as shown in FIG. 9. A protrusion length L1 of each terminal piece 424 protruding downward from the second board 40 is shorter than a protrusion length of one, protruding downward to the longest distance from the second board 40, of the plurality of electronic parts 441 (see FIG. 11) arranged on the lower surface of the second board 40. That is to say, the vertical dimension (protrusion length L1) of a portion, protruding downward from the second board 40, of each terminal piece 424 is shorter than the longest vertical dimension of one of the plurality of electronic parts 441. The lower end portion of the terminal piece 424 of each of the second terminals 42 is soldered to an associated output terminal portion 405 on the lower surface of the second board 40. This allows each of the second terminals 42 to be fixed, and electrically connected, to an associated output terminal portion 405.

As shown in FIG. 12, each of the second terminals 42 includes a pair of spring pieces 420. The pair of spring pieces 420 protrudes upward from the bottom of the pair of counter pieces 421 and faces each other. These spring pieces 420 tilts with respect to the vertical axis such that the gap between the pair of spring pieces 420 decreases toward their top.

The holder 41 further has a pair of insert ports 411. The pair of insert ports 411 are provided in a lower portion of the holder 41 and arranged side by side in the rightward/leftward direction. Each insert port 411 is cut open through the lower surface of the holder 41. As shown in FIG. 9, the pair of insert ports 411 are associated one to one with the pair of second holes 402 of the second board 40. Each insert port 411 is located over an associated one of the second holes 402.

The pair of insert ports 411 are associated one to one with the pair of housings 410. Each insert port 411 is located under an associated one of the housings 410. The top of each insert port 411 communicates with the bottom of its associated housing 410. The inner peripheral surface of each insert port 411 tilts with respect to the vertical axis such that when viewed vertically, the inner peripheral surface thereof comes closer to the center of the insert port 411, the closer to the top of the insert port 411.

The case 43 shown in FIG. 3 is arranged along the upper surface of the bottom plate portion 30 of the attachment member 3. The case 43 is formed in the shape of a box, of which the lower surface (i.e., a surface facing the bottom plate portion 30) is open.

In this embodiment, the case 43 includes a bottom plate 430, a pair of first side plates 431, a pair of second side plates 432, and a fixing plate 433. The bottom plate 430 is formed in the shape of a rectangular plate, of which the length (longitudinal axis) is parallel to the rightward/leftward direction. The pair of first side plates 431 respectively protrude downward from the right and left edges of the bottom plate 430. The pair of second side plates 432 respectively protrude downward from the front and rear edges of the bottom plate 430. The fixing plate 433 protrudes from one of the pair of second side plates 432 in an opposite direction from the other second side plate 432.

As shown in FIG. 11, each of the second side plates 432 includes a plurality of claws 434. The second board 40 is housed in the case 43. The second board 40 is supported by the plurality of claws 434 provided on the respective second side plates 432. This allows the second board 40 to be fixed into the case 43. Note that a jack of the power supply input section 400 protrudes out of the case 43 through a window cut through one of the first side plates 431.

In the case 43 shown in FIG. 3, the second side plate 432 that is not connected to the fixing plate 433 and the fixing plate 433 itself are each screwed onto the pair of side plate portions 31 of the attachment member 3. This allows the case 43 to be attached onto the attachment member 3. The bottom opening of the case 43 is closed with the bottom plate portion 30 of the attachment member 3. This reduces the chances of insects and other vermin entering the case 43.

As shown in FIG. 9, each of the second terminals 42 of the power supply device 4 is vertically aligned with its associated insert port 411 of the holder 41, its associated second hole 402 of the second board 40, the through hole 300, its associated first hole 225 of the first board 221, and its associated first terminal 21. That is to say, each of the second terminals 42, and its associated insert port 411, its associated second hole 402, the through hole 300, its associated first hole 225, and its associated first terminal 21, are arranged on a line parallel to the vertical axis. In other words, when viewed vertically, each second terminal 42 overlaps with its associated insert port 411, its associated second hole 402, the through hole 300, its associated first hole 225, and its associated first terminal 21.

The output power of the power supply device 4 is supplied to the light source section 2 via the connection member 5. The connection member 5 includes at least one conductor 50. In this embodiment, the connection member 5 includes a pair of conductors 50 as the at least one conductor 50. However, this is only an example and should not be construed as limiting. Alternatively, the connection member 5 may include only one conductor 50 or may even include three or more conductors 50. The pair of conductors 50 are associated one to one with not only the pair of first terminals 21 of the light source section 2 but also the pair of second terminals 42 of the power supply device 4 as well.

Each conductor 50 is made of a metallic material such as copper or a copper alloy. Each conductor 50 may be formed in the shape of a column, of which the axis is defined by the upward/downward direction. However, this is only an example and should not be construed as limiting. Alternatively, each conductor 50 may also be formed in any other non-columnar shape such as a plate shape or a prism shape.

Each conductor 50 vertically runs through its associated first hole 225, the through hole 300, its associated second hole 402, and its associated insert port 411. A lower end portion of each conductor 50 is located in the insertion hole 211 of its associated first terminal 21, and is in contact with respective tips of the supporting pieces 212 of the first terminal 21. This allows each conductor 50 to be electrically connected to its associated first terminal 21. Meanwhile, an upper end portion of each conductor 50 is located in its associated housing 410 of the holder 41 and is clamped, inside the housing 410, between the pair of spring pieces 420 of its associated second terminal 42. This allows each conductor 50 to be electrically connected to its associated second terminal 42.

The light source 11 of this embodiment further includes a cover 111 shown in FIG. 4. The cover 111 covers the light source section 2 from under it. The cover 111 linearly extends horizontally, and is formed in the shape of a shallow, compressed box with an opening at the top. The cover 111 may be made of a material with a property to diffuse light, such as an acrylic resin in a milky white color. The light emitted from each light emitter 220 of the light source section 2 is transmitted through, and emerges downwardly out of, the cover 111.

As shown in FIG. 2, front and rear ends of the cover 111 are provided with a pair of upwardly protruding latches 233. Having the pair of latches 233 caught by the pair of side plate portions 31 of the attachment member 3 allows the cover 111 to be detachably attached to the attachment member 3.

The light source 11 may be assembled, for example, in the following manner. First of all, the installer attaches the power supply device 4 and the light source section 2 to the attachment member 3.

Next, the installer passes each conductor 50 through the insertion hole 211 of its associated first terminal 21, its associated first hole 225, the through hole 300, its associated second hole 402, and its associated insert port 411 in this order such that the conductor 50 is clamped between the pair of spring pieces 420 of its associated second terminal 42. This brings one end of each conductor 50 into contact with the respective supporting pieces 212 of its associated first terminal 21 and also brings the other end thereof into contact with the pair of spring pieces 420 of its associated second terminal 42, thus electrically connecting the light source section 2 and the power supply device 4 together via the connection member 5.

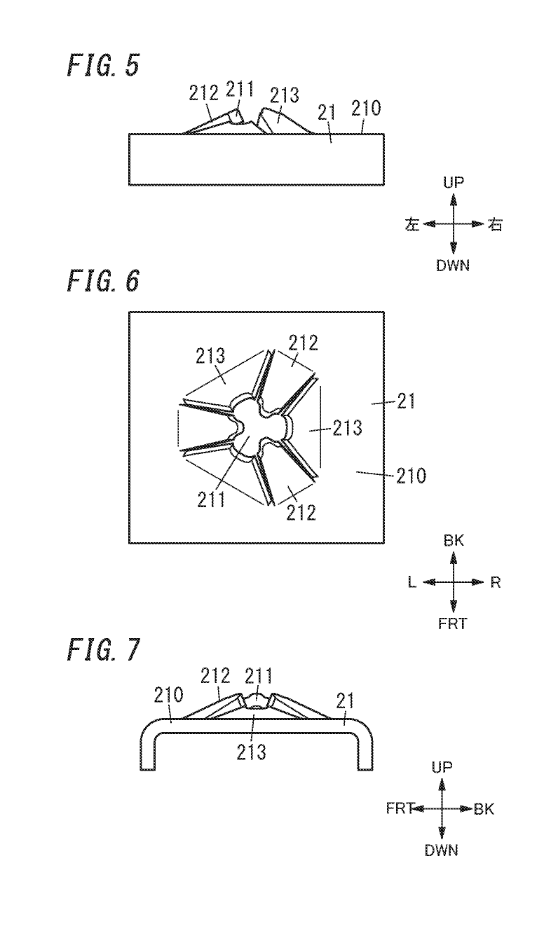

As described above, when inserted into the insertion hole 211 of its associated first terminal 21, each conductor 50 is guided toward the center of the insertion hole 211 by the plurality of supporting pieces 212 and the plurality of guide pieces 213, which are arranged so as to surround the insertion hole 211 as shown in FIG. 6. In addition, when inserted into the pair of spring pieces 420 of its associated second terminal 42, each conductor 50 shown in FIG. 9 is guided toward its corresponding position between the pair of spring pieces 420 by the tilted inner peripheral surface of its associated insert port 411 of the holder 41. This facilitates the installer's connecting the conductor 50 to the first terminal 21 and the second terminal 42.

After having electrically connected the light source section 2 and the power supply device 4 together via the connection member 5 as described above, the installer attaches the cover 111 shown in FIG. 4 to the attachment member 3. In this manner, the light source 11 is assembled.

As can be seen from the foregoing description, the light source 11 according to this embodiment allows the installer to electrically connect the light source section 2 and the power supply device 4 together easily just by passing each conductor 50 shown in FIG. 9 through the first hole 225 of the first board 221, the through hole 300 of the attachment member 3, and the second hole 402 of the second board 40.

In addition, the holder 41, holding the pair of second terminals 42, is arranged on the upper surface, facing away from the bottom plate portion 30 of the attachment member 3, of the second board 40. This allows the second board 40 to be arranged closer to the bottom plate portion 30 and also allows the pair of first terminals 21 of the light source section 2 and the pair of second terminals 42 of the power supply device 4 to be arranged closer to each other. This allows the vertical dimension of each conductor 50 to be shortened, thus reducing the chances of each conductor 50 producing radiation noise.

In addition, according to this embodiment, tall electronic parts 440 (see FIG. 10), serving as lead parts, are arranged on the upper surface, on which the holder 41 is arranged, of the second board 40. This reduces an increase in the number of less tall electronic parts in the power supply circuit 49 and also reduces an increase in the area of the second board 40.

In addition, the light source 11 further includes a plurality of hooks 110 as shown in FIG. 1. The plurality of hooks 110 are provided for the attachment member 3. The plurality of hooks 110 are caught in the recess 100 of the fixture body 10. This allows the light source 11 to be detachably attached to the fixture body 10.

The light fixture 1 may be installed, for example, in the following manner. First of all, the installer passes the power cable 93, which is exposed to the interior of a room through the ceiling panel 90, through the port 101 of the fixture body 10 to which the terminal stage 12 is attached. Next, the installer passes the plurality of suspension bolts 91, which are also exposed to the interior of the room through the ceiling panel 90, through the plurality of holes 102 of the fixture body 10.

Subsequently, the installer screws on a nut 92 to each of the plurality of suspension bolts 91 to fix the fixture body 10 onto the ceiling panel 90. Thereafter, the installer connects the power cable 93 to the terminal stage 12 and inserts and connects the plug connector 14 to the power supply input section 400 (see FIG. 11) of the power supply device 4. Then, the installer has the plurality of hooks 110 caught in the recess 100 of the fixture body 10, thus attaching the light source 11 to the fixture body 10. In this manner, the light fixture 1 is installed onto the ceiling.

Next, variations of the light fixture 1 will be enumerated one after another.

### First Variation

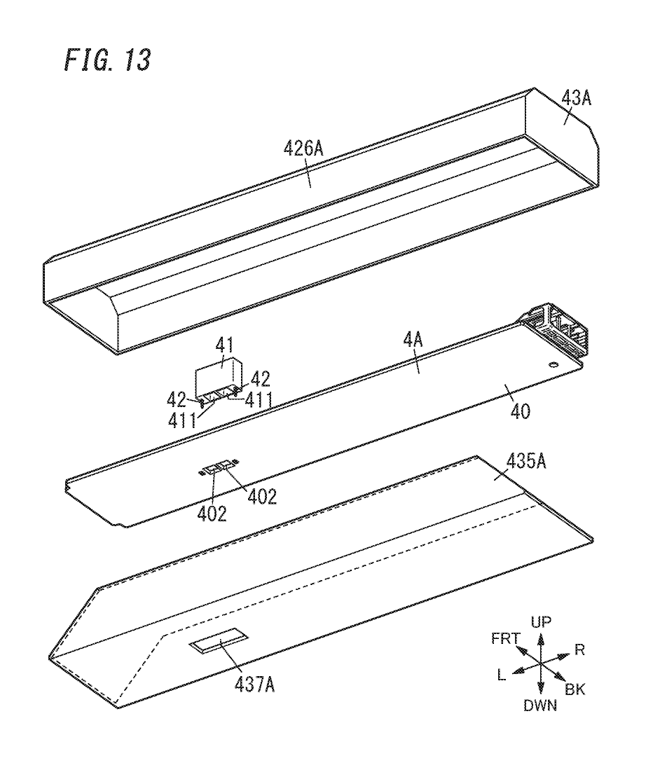

FIG. 13 illustrates a power supply device 4A according to a first variation. The power supply device 4A includes a case 43A in place of the case 43 (see FIG. 3). The case 43A includes a case body 435A and a case lid 426A. The case body 435A may be made of a metallic material, for example. The case body 435A extends linearly in the rightward/leftward direction, and is formed in the shape of a box, of which the upper surface is open. The case body 435A is arranged along the lower surface of the second board 40. The second board 40 is attached to the case body 435A. The case body 435A is attached in turn to the attachment member 3 (see FIG. 3).

The case lid 426A may be made of a metallic material, for example. The case lid 426A is located over the case body 435A and the second board 40. The case lid 426A extends linearly in the rightward/leftward direction, and is formed in the shape of a box, of which the lower surface is open. The case lid 426A is attached to the case body 435A so that the lower surface of the case lid 426A is closed with the case body 435A. The second board 40, the plurality of electronic parts 44, and the holder 41 are housed in the space surrounded with the case lid 426A and the case body 435A.

The case 43A further has a hole 437A. The hole 437A is cut through, and vertically runs through, the case body 435A. When viewed vertically, the hole 437A overlaps with the pair of second holes 402 of the second board 40 and the through hole 300 of the attachment member 3 (see FIG. 3). That is to say, in this variation, each conductor 50 (see FIG. 9) vertically runs through its associated first hole 225 (see FIG. 9), the through hole 300 (see FIG. 9), the hole 437A, its associated second hole 402, and its associated insert port 411. In that state, each conductor 50 is electrically connected to its associated first terminal 21 (see FIG. 9) and its associated second terminal 42.

Optionally, the power supply device 4A according to this variation may include an insulating sheet, which is arranged between the case body 435A and the second board 40.

### Second Variation

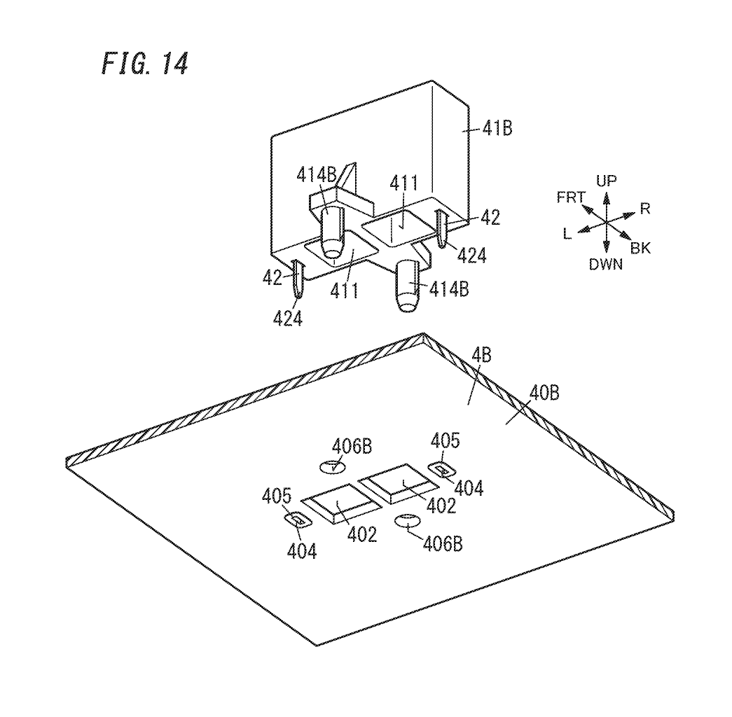

FIG. 14 illustrates a power supply device 4B according to a second variation. The power supply device 4B includes a second board 40B in place of the second board 40 (see FIG. 3) and a holder 41B in place of the holder 41 (see FIG. 3). The second board 40B has substantially the same configuration as the second board 40 of the exemplary embodiment described above. Thus, the following description of the second board 40B will be focused on only differences from the second board 40 of the exemplary embodiment. The holder 41B has substantially the same configuration as the holder 41 of the exemplary embodiment described above. Thus, the following description of the holder 41B will be focused on only differences from the holder 41 of the exemplary embodiment.

The second board 40B further has at least one fitting hole 406B. In this variation, the second board 40B has a pair of fitting holes 406B as the at least one fitting hole 406B. However, this is only an example and should not be construed as limiting. Alternatively, the second board 40B may have only one fitting hole 406B or may even have three or more fitting holes 406B.

The pair of fitting holes 406B are arranged side by side in the forward/backward direction and the pair of second holes 402 are located between the pair of fitting holes 406B. Each of these fitting holes 406B vertically runs through the second board 40B.

The holder 41B includes at least one projection 414B. In this variation, the holder 41B includes plurality of projections 414B as the at least one projection 414B. The plurality of projections 414B are formed integrally with the rest of the holder 41B. In this variation, the holder 41B includes a pair of projections 414B as the plurality of projections 414B. However, this is only an example and should not be construed as limiting. Alternatively, the holder 41B may include only one projection 414B or may even have three or more projections 414B.

The pair of projections 414B are respectively provided at a center of the bottom of a front portion of the holder 41B and at a center of the bottom of a rear portion of the holder 41B. These projections 414B protrude downward from the lower surface, having the pair of insert ports 411, of the holder 41B.

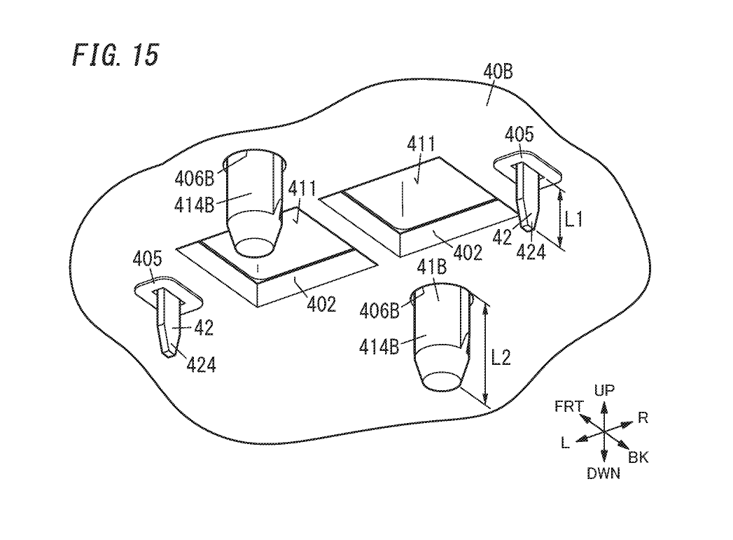

As shown in FIG. 15, the respective projections 414B of the holder 41B are fitted into their associated fitting holes 406B. These projections 414B are fitted in a compressed state into their associated fitting holes 406B. This allows the holder 41B to be firmly fixed onto the second board 40B.

Each projection 414B runs through its associated fitting hole 406B to protrude downward from the lower surface of the second board 40B. A protrusion length L2 of each projection 414B protruding downward from the second board 40B is shorter than the protrusion length of one, protruding downward to the longest distance from the second board 40B, of the plurality of electronic parts 441 (see FIG. 11) arranged on the lower surface of the second board 40B. In other words, the vertical dimension L2 of a portion, protruding downward from the second board 40B, of each projection 414B is shorter than the longest vertical dimension of one of the plurality of electronic parts 441. This allows the second board 40B to be arranged closer to the bottom plate portion 30 of the attachment member 3.

In the example illustrated in FIG. 15, the protrusion length L2 of each projection 414B is longer than the protrusion length L1 of each terminal piece 424 protruding downward from the second board 40B. However, this is only an example and should not be construed as limiting. Alternatively, the protrusion length L2 may be equal to or less than the protrusion length L1. In addition, the number of the projections 414B that the holder 41B has does not have to be two but may also be one or even three or more.

### Third Variation

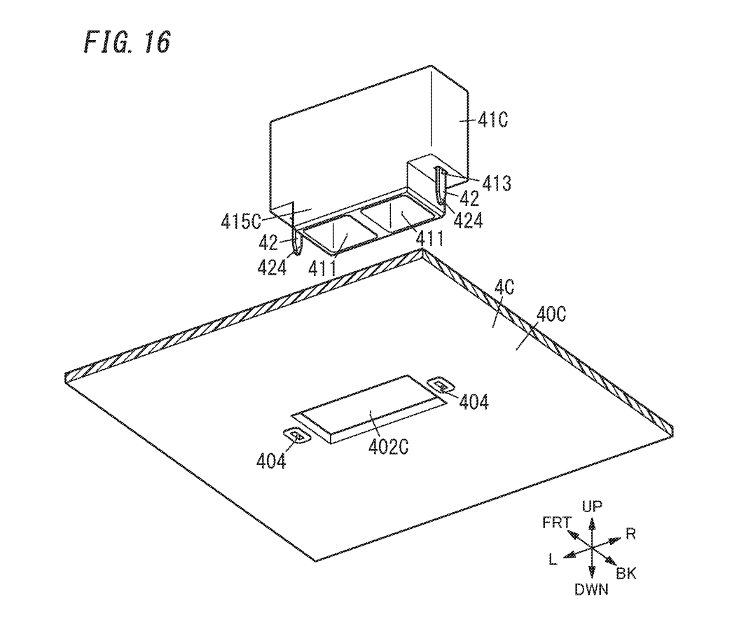

FIG. 16 illustrates a power supply device 4C according to a third variation. The power supply device 4C includes a second board 40C in place of the second board 40 (see FIG. 3) and a holder 41C in place of the holder 41 (see FIG. 3). The second board 40C has substantially the same configuration as the second board 40 of the exemplary embodiment described above.

Thus, the following description of the second board 40C will be focused on only differences from the second board 40 of the exemplary embodiment. The holder 41C has substantially the same configuration as the holder 41 of the exemplary embodiment described above. Thus, the following description of the holder 41C will be focused on only differences from the holder 41 of the exemplary embodiment.

The second board 40C has a single second hole 402C instead of the pair of second holes 402 (see FIG. 3). The second hole 402C is located between the pair of through holes 404. The second hole 420C vertically runs through the second board 40C. The second hole 402C is a hole in the shape of a rectangle, of which the length (longitudinal axis) is parallel to the rightward/leftward direction.

The holder 41C further includes a protruding portion 415C. The protruding portion 415C is provided at a center in the rightward/leftward direction of a lower end portion of the holder 41C. The protruding portion 415C is formed in the shape of a rectangle matching the shape of the second hole 402C when viewed vertically. The lower surface of the protruding portion 415C is located one step lower than the lower surface of right and left end portions of the holder 41C. The pair of insert ports 411 are cut open through the lower surface of the protruding portion 415C. The pair of housing holes 413 are cut open through the lower surface of the right and left end portions of the holder 41C. The pair of terminal pieces 424 protrude downward from the lower surface of the right and left end portions of the holder 41C.

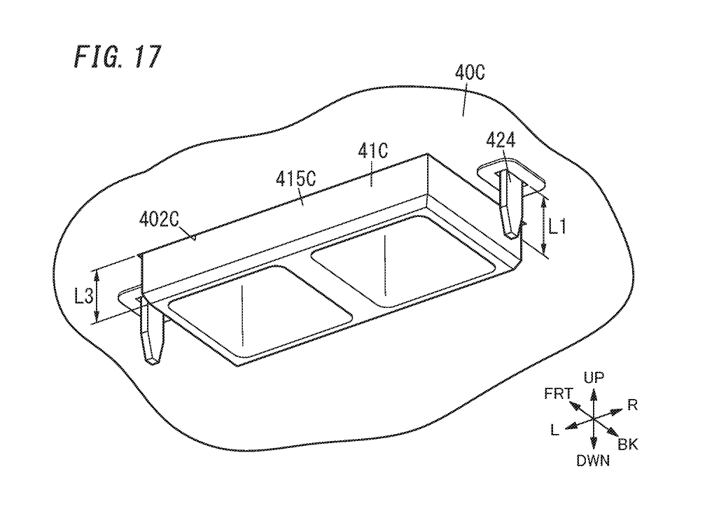

As shown in FIG. 17, the protruding portion 415C of the holder 41C is fitted into the second hole 402C. The protruding portion 415C is fitted in a compressed state into the second hole 402C. This allows the holder 41C to be firmly fixed onto the second board 40C.

The protruding portion 415C runs through the second hole 402C to protrude downward from the lower surface of the second board 40C. A protrusion length L3 of the protruding portion 415C protruding downward from the second board 40C is shorter than the protrusion length of one, protruding downward to the longest distance from the second board 40C, of the plurality of electronic parts 441 (see FIG. 11) arranged on the lower surface of the second board 40C. In other words, the vertical dimension (protrusion length L3) of a portion, protruding downward from the second board 40C, of the protruding portion 415C is shorter than the longest vertical dimension of one of the plurality of electronic parts 441. This allows the second board 40C to be arranged closer to the bottom plate portion 30 of the attachment member 3.

In the example illustrated in FIG. 17, the protrusion length L3 of the protruding portion 415C is longer than the protrusion length L1 of each terminal piece 424 protruding downward from the second board 40C. However, this is only an example and should not be construed as limiting. Alternatively, the protrusion length L3 may be equal to or less than the protrusion length L1. Optionally, the holder 41C according to this variation may include the projections 414B (see FIG. 15) of the second variation. In that case, the second board 40C may have fitting holes 406B to which the protrusions 414B are fitted.

### Fourth Variation

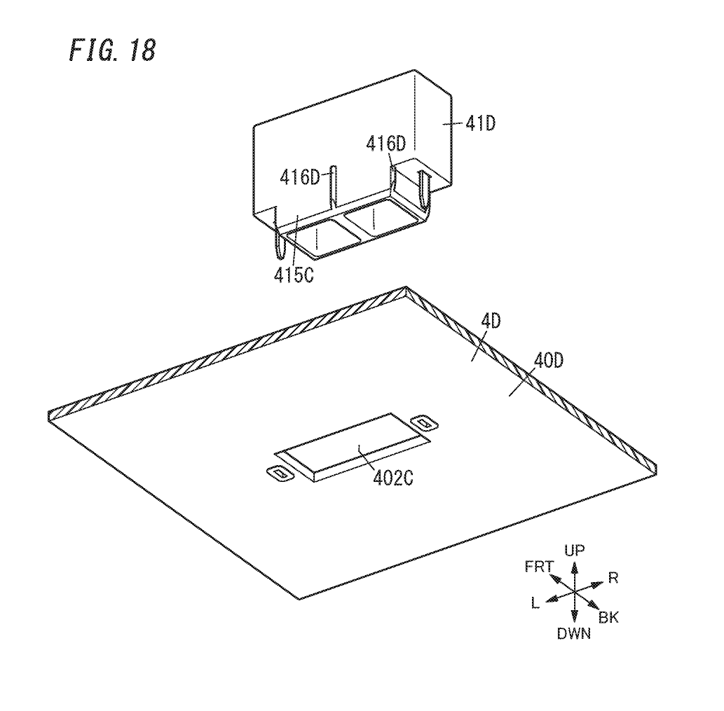

FIG. 18 illustrates a power supply device 4D according to a fourth variation. The power supply device 4D includes a second board 40D in place of the second board 40 (see FIG. 3) and a holder 41D in place of the holder 41 (see FIG. 3). The second board 40D has the same configuration as the second board 40C (see FIG. 16) of the third variation described above. Thus, a detailed description of the second board 40D will be omitted herein. The holder 41D has substantially the same configuration as the holder 41C (see FIG. 16) of the third variation described above. Thus, the following description of the holder 41D will be focused on only differences from the holder 41C of the third variation.

The holder 41D further includes a plurality of projections 416D. The plurality of projections 416D are formed on an outer peripheral surface of a portion, configured to be fitted into the second hole 402C, of the protruding portion 415C. In this variation, the holder 41D includes six projections 416D as the plurality of projections 416D. The six projections 416D are respectively provided at the four corners of the protruding portion 415C, having a rectangular shape when viewed vertically, and at respective centers in the rightward/leftward direction of the front and rear surfaces of the protruding portion 415C. Each of these projections 416D linearly extends upward from the bottom of the protruding portion 415C.

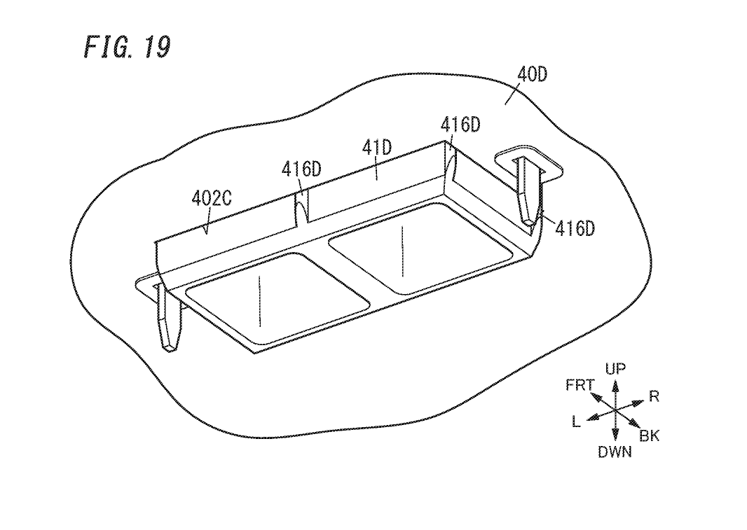

As shown in FIG. 19, the respective projections 416D are in contact, in a compressed state, with the inner peripheral surface of the second hole 402C of the second board 40D. This allows the holder 41D to be fixed more firmly onto the second board 40D.

The bottom surface of each of the projections 416D tilts so as to upwardly slope away from the outer peripheral surface of the protruding portion 415C. This allows the protruding portion 415C with the plurality of projections 416D to be downwardly inserted into the second hole 402C easily. Note that the number of the projections 416D that the holder 41D has does not have to be six.

### Fifth Variation

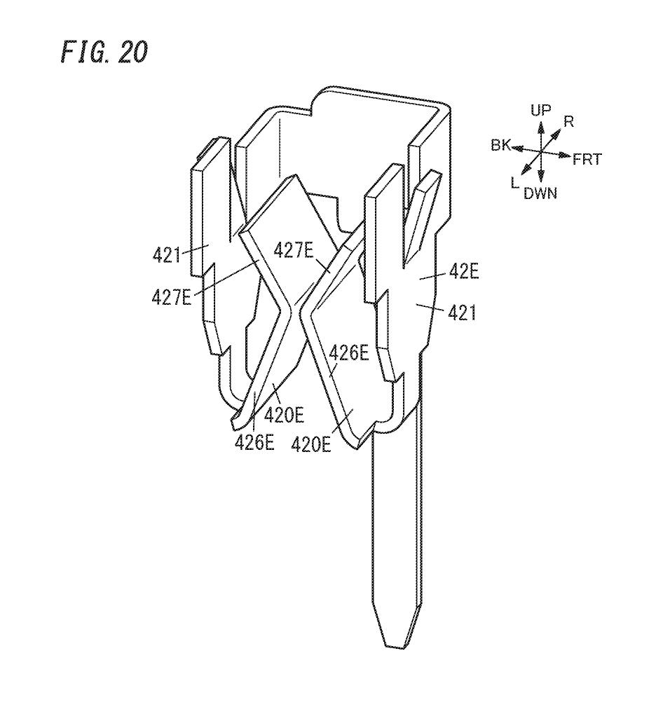

FIG. 20 illustrates a second terminal 42E according to a fifth variation. The second terminal 42E has substantially the same configuration as the second terminal 42 (see FIG. 12) of the exemplary embodiment described above. Thus, the following description of the second terminal 42E will be focused on only differences from the second terminal 42 of the exemplary embodiment.

The second terminal 42E according to this variation is configured such that the conductor 50 may be upwardly connected thereto from under itself (i.e., from one side, facing the bottom plate portion 30, of the second terminal 42E) and downwardly connected thereto from over itself (i.e., from the other side, facing away from the bottom plate portion 30, of the second terminal 42E). Specifically, the second terminal 42E includes a pair of spring pieces 420E in place of the pair of spring pieces 420 (see FIG. 12). Each of these spring pieces 420E is bent into an L shape when viewed in the rightward/leftward direction and includes a first portion 426E and a second portion 427E. In each spring piece 420E, the first portion 426E thereof protrudes upward from the bottom of its associated counter piece 421 and the second portion 427E thereof protrudes upward from the top of the first portion 426E. In the pair of spring pieces 420E, their respective first portions 426E face each other and their respective second portions 427E also face each other. Note that in each spring piece 420E, the vertical dimension of the second portion 427E is suitably longer than one-third of the vertical dimension of the first portion 426E. In this variation, the vertical dimension of the second portion 427E is longer than a half of the vertical dimension of the first portion 426E.

The first portion 426E of each spring piece 420E tilts with respect to the vertical axis such that the gap between the respective first portions 426E of the pair of spring pieces 420E decreases toward their top. Meanwhile, the second portion 427E of each spring piece 420E tilts with respect to the vertical axis such that the gap between the respective second portions 427E of the pair of spring pieces 420E increases toward their top.

The conductor 50 (see FIG. 8), brought into contact with a connecting portion between the first and second portions 426E and 427E of each spring piece 420E, is clamped between the pair of spring pieces 420E.

The second terminal 42E of this embodiment is configured such that the conductor 50 may be inserted into the gap between the pair of spring pieces 420E both from under and from over the second terminal 42E. The first portion 426E of each spring piece 420E serves as a guide for the conductor 50 when the conductor 50 is inserted into the gap between the pair of spring pieces 420E from under the second terminal 42E. On the other hand, the second portion 427E of each spring piece 420E serves as a guide for the conductor 50 when the conductor 50 is inserted into the gap between the pair of spring pieces 420E from over the second terminal 42E.

The second terminal 42E according to this variation may also be used, for example, in a power supply device in which the holder 41 (see FIG. 3) is arranged on the lower surface of the second board 40 (see FIG. 3). In that case, the second terminal 42E will be arranged upside down, compared to the situation where the holder 41 is arranged on the upper surface of the second board 40, and will be held by the holder 41 attached to the lower surface of the second board 40. Then, the conductor 50 will be connected to the second terminal 42E from under the second terminal 42E. Optionally, the second terminal 42E of this variation may also replace the second terminal 42 of any one of the first to fourth variations.

### Aspects

As can be seen from the foregoing description of embodiments and first to fifth variations, a light source (11) according to a first aspect includes an attachment member (3), a light source section (2), a power supply device (4; 4A-4D), and at least one conductor (50). The light source section (2) and the power supply device (4; 4A-4D) are attached to the attachment member (3). The attachment member (3) includes a plate portion (bottom plate portion (30)) and a through hole (300). The through hole (300) is cut through the plate portion so as to run through the plate portion in a thickness direction (D) thereof. The light source section (2) includes a first board (221), a light emitter (220), at least one first terminal (21), and at least one first hole (225). The first board (221) is arranged along one of two surfaces of the plate portion. The two surfaces face each other in the thickness direction (D) of the plate portion. The light emitter (220) is attached to the first board (221). The at least one first terminal (21) is attached to the first board (221) and electrically connected to the light emitter (220). The at least one first hole (225) runs through the first board (221) in the thickness direction (D). The power supply device (4; 4A-4D) includes a power supply circuit (49). The power supply circuit (49) includes a second board (40; 40B-40D), at least one second hole (402; 402C), a holder (41; 41B-41D), and at least one second terminal (42; 42E). The second board (40; 40B-40D) is arranged along the other of the two surfaces, facing away from the first board (221), of the plate portion. The at least one second hole (402; 402C) runs through the second board (40; 40B-40D) in the thickness direction (D). The holder (41; 41B-41D) is arranged on one of two surfaces, facing away from the plate portion, of the second board (40; 40B; 40C). The at least one second terminal (42; 42E) is held by the holder (41; 41B-41D) to output power generated by the power supply circuit (49). The at least one first terminal (21), the at least one first hole (225), the through hole (300), the at least one second hole (402; 402C), and the at least one second terminal (42; 42E) overlap with each other in the thickness direction (D). The at least one conductor (50) is electrically connected to the at least one first terminal (21) and the at least one second terminal (42; 42E) through the at least one first hole (225), the through hole (300), and the at least one second hole (402; 402C).

The first aspect allows the installer to electrically connect the light source section (2) to the power supply device (4; 4A-4D) easily just by passing the conductor (50) through the first hole (225), the through hole (300), and the second hole (402; 402C). In addition, the holder (41; 41B-41D) for holding the second terminal (42; 42E) is arranged on one surface, facing away from the plate portion of the attachment member (3), of the second board (40; 40B-40D). This allows the second board (40; 40B-40D) to be arranged closer to the plate portion and also allows the first terminal (21) and the second terminal (42; 42E) to be arranged closer to each other, thus shortening the conductor (50) and eventually reducing the chances of the conductor (50) producing radiation noise.

A light source (11) according to a second aspect may be implemented in combination with the first aspect. The light source (11) according to the second aspect may have the following configuration. The second board (40B) further includes at least one fitting hole (406B). The at least one fitting hole (406B) runs through the second board (40B) in the thickness direction (D). The holder (41B) includes at least one projection (414B). The at least one projection (414B) protrudes toward the second board (40B). The at least one projection (414B) is fitted into the at least one fitting hole (406B).

According to the second aspect, fitting the projection (414B) into the fitting hole (406B) allows the holder (41B) to be firmly fixed onto the second board (40B).

A light source (11) according to a third aspect may be implemented in combination with the second aspect. The light source (11) according to the third aspect may have the following configuration. The power supply circuit (49) further includes an electronic part (441). The electronic part (441) is arranged on the other surface, facing the plate portion, of the second board (40B). The at least one projection (414B) protrudes from the second board (40B) toward the plate portion. A protrusion length (L2) of the at least one projection (414B) protruding from the second board (40B) toward the plate portion is shorter than a protrusion length of the electronic part (441) protruding from the second board (40B) toward the plate portion.

The third aspect allows, even though the holder (41B) has the projection (414B), the second board (40B) to be arranged closer to the plate portion of the attachment member (3).

A light source (11) according to a fourth aspect may be implemented in combination with the first aspect. The light source (11) according to the fourth aspect may have the following configuration. The holder (41C) includes a protruding portion (415C). The protruding portion (415C) protrudes toward the second board (40C) and is fitted into the at least one second hole (402C).

According to the fourth aspect, fitting the protruding portion (415C) into the second hole (402C) allows the holder (41C) to be firmly fixed onto the second board (40C).

A light source (11) according to a fifth aspect may be implemented in combination with the fourth aspect. The light source (11) according to the fifth aspect may have the following configuration. The power supply circuit (49) further includes an electronic part (441). The electronic part (441) is arranged on the other of the two surfaces, facing the plate portion, of the second board (40B). The protruding portion (415C) protrudes from the second board (40C) toward the plate portion. A protrusion length (L3) of the protruding portion (415C) protruding from the second board (40C) toward the plate portion is shorter than a protrusion length of the electronic part (441) protruding from the second board (40C) toward the plate portion.

The fifth aspect allows, even though the holder (41C) includes the protruding portion (415C), the second board (40C) to be arranged closer to the plate portion of the attachment member (3).

A light source (11) according to a sixth aspect may be implemented in combination with any one of the first to fifth aspects. The light source (11) according to the sixth aspect may have the following configuration. The power supply device (4) further includes a case (43). The case (43) is arranged along the other of the two surfaces, facing the second board (40), of the plate portion and formed in a shape of a box. One side, facing the plate portion, of the box has an opening. The power supply circuit (49) is housed in the case (43). The opening, facing the plate portion, of the case (43) is closed with the plate portion.

The sixth aspect allows the opening of the box-shaped case (43) to be closed with the plate portion, thus reducing the chances of insects and other vermin entering the case (43) in which the power supply circuit (49) is housed.

A light fixture (1) according to a seventh aspect includes a light source (11) and a fixture body (10). The light fixture (1) according to the seventh aspect may have the following configuration. The light source (11) is the light source (11) according to any one of the first to sixth aspects. The fixture body (10) supports the light source (11).

The seventh aspect provides a light fixture (1) in which the light source (11) is supported by the fixture body (10).

A power supply device (4; 4A-4D) according to an eighth aspect includes a power supply circuit (49). The power supply circuit (49) includes a board (second board) (40; 40B; 40C), at least one hole (second hole) (402; 402C), a holder (41; 41B; 41C), and at least one terminal (second terminal) (42; 42E). The at least one hole (402; 402C) is cut through the board (40; 40B; 40C) so as to run through the board (40; 40B; 40C) in a thickness direction thereof. The holder (41; 41B; 41C) is arranged on one of two surfaces of the board (40; 40B; 40C). The two surfaces face each other in the thickness direction. The at least one terminal (42; 42E) is held by the holder (41; 41B; 41C) to output power generated by the power supply circuit (49). The at least one hole (402; 402C) is cut through a portion of the board, located to face the at least one terminal (42; 42E), of the board (40; 40B; 40C).

The eighth aspect allows the installer to electrically connect the conductor (50) to the terminal (42) by passing the conductor (50) through the hole (402; 402C). That is to say, the terminal (42; 42E) is configured to be connected to the conductor (50) passed through the hole (402; 402C). Thus, in a situation where a load to be supplied with the power (namely, the light source section (2)) is located opposite from the holder (41; 41B; 41C) with respect to the board (40; 40B; 40C) with another member (namely, the attachment member (3)) interposed as in the light fixture (1) described above, the load may be electrically connected easily to the power supply device (4; 4A-4D) via the conductor (50). In addition, this also allows the board (40; 40B; 40C) to be arranged closer to the other member, thus shortening the conductor (50) and eventually reducing the chances of the conductor (50) producing radiation noise.

A light source (11) according to a ninth aspect may be implemented in combination with any one of the first to sixth aspects. The light source (11) according to the ninth aspect may have the following configuration. The light source section (2) includes a pair of first terminals (21) as the at least one first terminal (21). The power supply circuit (49) includes a pair of second terminals (42; 42E) as the at least one second terminal (42; 42E). The light source (11) includes a pair of conductors (50) as the at least one conductor (50). The pair of conductors (50) are respectively associated with the pair of first terminals (21) and also respectively associated with the pair of second terminals (42; 42E). The pair of conductors (50) is electrically connected to the pair of first terminals (21) and the pair of second terminals (42; 42E) through the at least one first hole (225) and the at least one second hole (402; 402C).

A light source (11) according to a tenth aspect may be implemented in combination with any one of the first to sixth and ninth aspects. The light source (11) according to the tenth aspect may have the following configuration. The power supply circuit (49) has only one second hole (402C).

A light source (11) according to an eleventh aspect may be implemented in combination with any one of the first to sixth, ninth, and tenth aspects. The light source (11) according to the eleventh aspect may have the following configuration. The at least one conductor (50) may be connected to the at least one second terminal (42E) both from one side, facing the plate portion, of the at least one second terminal (42E) and from the other side, facing away from the plate portion, of the at least one second terminal (42E).

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A light source, comprising:
an attachment member;
a light source section attached to the attachment member;
a power supply device attached to the attachment member; and
at least one conductor,
wherein the attachment member includes:
a plate portion; and
a through hole cut through the plate portion so as to run through the plate portion in a thickness direction of the plate portion,
wherein the light source section includes:
a first board arranged along one of two surfaces of the plate portion, the two surfaces facing each other in the thickness direction of the plate portion;
a light emitter attached to the first board;
at least one first terminal attached to the first board and electrically connected to the light emitter; and
at least one first hole running through the first board in the thickness direction,
wherein the power supply device includes a power supply circuit,
wherein the power supply circuit includes:
a second board arranged along the other of the two surfaces, facing away from the first board, of the plate portion;
at least one second hole running through the second board in the thickness direction;
a holder arranged along one of two surfaces, facing away from the plate portion, of the second board; and
at least one second terminal held by the holder to output power generated by the power supply circuit,
wherein the at least one first terminal, the at least one first hole, the through hole, the at least one second hole, and the at least one second terminal overlap with each other in the thickness direction, and
wherein the conductor is electrically connected to the at least one first terminal and the at least one second terminal through the at least one first hole, the through hole, and the at least one second hole.

2. The light source of claim 1,
wherein the second board further includes at least one fitting hole running through the second board in the thickness direction,
the holder includes at least one projection protruding toward the second board, and
the at least one projection is fitted into the at least one fitting hole.

3. The light source of claim 2,
wherein the power supply circuit further includes an electronic part arranged on the other surface, facing the plate portion, of the second board,
the at least one projection protrudes from the second board toward the plate portion, and
a protrusion length of the at least one projection protruding from the second board toward the plate portion is shorter than a protrusion length of the electronic part protruding from the second board toward the plate portion.

4. The light source of claim 1,
wherein the holder includes a protruding portion, the protruding portion protruding toward the second board and fitted into the at least one second hole.

5. The light source of claim 2,
wherein the holder includes a protruding portion, the protruding portion protruding toward the second board and fitted into the at least one second hole.

6. The light source of claim 4,
wherein the power supply circuit further includes an electronic part arranged on the other of the two surfaces, facing the plate portion, of the second board,
the protruding portion protrudes from the second board toward the plate portion, and
a protrusion length of the protruding portion protruding from the second board toward the plate portion is shorter than a protrusion length of the electronic part protruding from the second board toward the plate portion.

7. The light source of claim 5,
wherein the power supply circuit further includes an electronic part arranged on the other of the two surfaces, facing the plate portion, of the second board,
the protruding portion protrudes from the second board toward the plate portion, and
a protrusion length of the protruding portion protruding from the second board toward the plate portion is shorter than a protrusion length of the electronic part protruding from the second board toward the plate portion.

8. The light source of claim 1,
wherein the power supply device further includes a case arranged along the other of the two surfaces, facing the second board, of the plate portion and formed in a shape of a box, one side, facing the plate portion, of the box being opened,
the power supply circuit is housed in the case, and
the side, facing the plate portion, of the case is closed with the plate portion.

9. A light fixture, comprising:
the light source of claim 1; and
a fixture body configured to support the light source.

10. A power supply device comprising:
a power supply circuit,
wherein the power supply circuit includes:
a board;
at least one hole cut through the board so as to run through the board in a thickness direction of the board;
a holder arranged on one of two surfaces of the board, the two surfaces facing each other in the thickness direction; and
at least one terminal held by the holder to output power generated by the power supply circuit,
wherein the at least one hole is cut through a portion of the board located to face the at least one terminal.
